(19) United States
(12) Patent Application Publication
(10) Pub. No.: US 2020/0285707 A1
(43) Pub. Date: Sep. 10, 2020

(54) MULTI-PERSON MODE FULL-LANGUAGE IMPLEMENTATION METHOD AND RELATED PRODUCT

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 16/420,375

(22) Filed: May 23, 2019

(30) Foreign Application Priority Data
Mar. 7, 2019 (CN) 201910173474.9

(51) Int. Cl. G06F 17/28; G10L 15/00; G06N 3/08

(52) U.S. Cl. CPC G06F 17/289; G06N 3/08; G10L 15/005

(57) ABSTRACT

The present application provide a multi-person mode full-language implementation method and the related product, wherein the method comprises: when the terminal determines the multi-person conference, acquiring the first voice, and determining the first language of the first voice; transmitting the first language to the network side, and receiving the first parameter that the first language transmitted by the network side is translated to the second language, and the second parameter that the first language is translated to the third language; loading the first parameter to the first branch of the AI translator and the second parameter to the second branch of the AI translator; inputting the first language into the first branch and the second branch of the AI translator respectively, to perform a cyclic neural network calculation to obtain the first calculation result and the second calculation result.

### CROSS REFERENCE TO RELATED APPLICATIONS

The present application claims the benefit of Chinese Patent Application No. 201910173474.9 filed on Mar. 7, 2019, the contents of which are incorporated herein by reference in their entirety.

### TECHNICAL FIELD

The present application relates to the field of communications and terminals, and in particular, to a multi-person mode full-language implementation method and the related product.

### BACKGROUND

A terminal comprises such as a tablet, a smart phone, etc. Nowadays, taking a smart phone as an example, a smart phone refers to the general name which is provided with a stand-alone operating system and separate running space like a personal computer, enables users to install a program provided by the third-party service provider such as software, games, navigation, etc. by themselves, and connects the wireless network to a smart phone through the mobile communication network.

The current smart phone call is just a forwarding of the call, for example, Tom calls Dick, and the Chinese voice of Tom is directly forwarded to Dick. If Dick is an American, Dick needs to know Chinese to understand. On the contrary, Tom needs to communicate with Dick in English. In this way, there is a certain threshold for communication. With the development of communication networks, multi-person calls have become the norm, such as conference calls, etc., especially the scene of a teleconference technology discussion. In this way, it is possible to use different languages, so that participants need to understand multiple languages at the same time, and even human translators need to be configured, which is inefficient and costly.

### SUMMARY

The embodiments of the present application provide a multi-person mode full-language implementation method and the related product, which realizes simultaneous translation of multi-person calls, reduces the cost, and improves user experience.

According to the first embodiment, the present application provides a multi-person mode full-language implementation method, wherein the method comprises the steps of:

when the terminal determines the multi-person conference, acquiring the first voice, and determining the first language of the first voice;

transmitting, by the terminal, the first language to the network side, and receiving the first parameter that the first language transmitted by the network side is translated to the second language, and the second parameter that the first language is translated to the third language;

loading, by the terminal, the first parameter to the first branch of the AI translator and the second parameter to the second branch of the AI translator; and

inputting, by the terminal, the first language into the first branch and the second branch of the AI translator, respectively, to perform a cyclic neural network calculation to obtain the first calculation result and the second calculation result, obtaining the second voice matching with the second language according to the first calculation result, obtaining the third voice matching with the third language according to the second calculation result, and transmitting the second voice and the third voice to the network side.

Preferably, the terminal inputs the first language into the first branch of the AI translator to perform a cyclic neural network operation to obtain the first calculation result, which specifically comprises:

obtaining the input data Xₜ and the weight W at the time t of the input layer of the cyclic neural network in the first branch, obtaining the output result Sₜ₋₁ at the previous time of the time t of the hidden layer; and calculating the output result Sₜ at the time t of the hidden layer and the first calculation result Oₜ at the time t of the output layer.

Preferably, the terminal inputs the first language into the second branch of the AI translator to perform the cyclic neural network operation to obtain the second calculation result, which specifically comprises:

obtaining the input data Xₜ and the weight W² at the time t of the input layer of the cyclic neural network in the second branch, obtaining the output result Sₜ₋₁² at the previous time of the time t of the hidden layer; and calculating the output result Sₜ² at the time t of the hidden layer and the second calculation result Oₜ² at the time t of the output layer.

Preferably, calculating the output result Sₜ at the time t of the hidden layer specifically comprises:

adding the matrix hₜ₋₁*M of the output result Sₜ₋₁ to the matrix hₜ*M of the input data Xₜ to obtain a new matrix (hₜ₋₁+hₜ)*M, where M denotes the row value of the matrix, hₜ₋₁ and hₜ denote the column value of the matrix; calculating the matrix (hₜ₋₁+hₜ)*M and the matrix M*E of the weight W to obtain the calculation result (hₜ₋₁+hₜ)*E, dividing the calculation result ((hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

According to the second embodiment, there is provided a terminal, wherein the terminal comprises: an audio acquiring component, a processing unit, and a communication unit;

the audio acquiring component is configured to, when determining the multi-person conference, acquire the first voice and determine the first language of the first voice;

the processing unit is configured to control the communication unit to transmit the first language to the network side, and receive the first parameter that the first language transmitted by the network side is translated to the second language, and the second parameter that the first language is translated to the third language; load the first parameter to the first branch of the AI translator and the second parameter to the second branch of the AI translator; and input the first language into the first branch and the second branch of the AI translator, respectively, to perform a cyclic neural network calculation to obtain the first calculation result and the second calculation result, obtain the second voice matching with the second language according to the first calculation result, obtain the third voice matching with the third language according to the second calculation result, and control the communication unit to transmit the second voice and the third voice to the network side.

Preferably, the processing unit is specifically configured to obtain the input data Xₜ and the weight W at the time t of the input layer of the cyclic neural network in the first branch, obtain the output result Sₜ₋₁ at the previous time of the time t of the hidden layer; and calculate the output result Sₜ at the time t of the hidden layer and the first calculation result Oₜ at the time t of the output layer.

Preferably, the processing unit is specifically configured to obtain the input data Xₜ and the weight W² at the time t of the input layer of the cyclic neural network in the second branch, obtain the output result Sₜ₋₁² at the previous time of the time t of the hidden layer; and calculate the output result Sₜ² at the time t of the hidden layer and the second calculation result Oₜ² at the time t of the output layer.

Preferably, the processing unit is specifically configured to add the matrix hₜ₋₁*M of the output result Sₜ₋₁ to the matrix hₜ*M of the input data Xₜ to obtain a new matrix (hₜ₋₁+hₜ)*M, where M denotes the row value of the matrix, hₜ₋₁ and hₜ denote the column value of the matrix; calculate the matrix (hₜ₋₁+hₜ)*M and the matrix M*E of the weight W to obtain the calculation result (hₜ₋₁+hₜ)*E, divide the calculation result ((hₜ₋₁+hₜ)*E into the matrix hₜ₋₁*E and the matrix hₜ*E, sum the matrix hₜ₋₁*E and the matrix hₜ*E to obtain an output result Sₜ; and perform an activation operation on Sₜ to obtain Oₜ.

Preferably, the terminal is a smart phone or a tablet.

According to the third embodiment, there is provided a computer readable storage medium in which a computer program for exchanging electronic data is stored, wherein the computer program causes the computer to perform the method provided by the first aspect.

According to the fourth embodiment, there is provided a computer program product, wherein the computer program product comprises a non-transitory computer readable storage medium in which a computer program is stored, and the computer program is operable to cause the computer to perform the method provided by the first aspect.

The implementation of the embodiments of the present application has the following beneficial effects.

It can be seen that the technical solution provided by the present application calls the cyclic neural network to translate the original language to obtain a translated language when determining that the original language of the first game is inconsistent with the system language, and displays or plays the translated language, thereby translating the language of the first game to improve the user experience.

### BRIEF DESCRIPTION OF THE DRAWINGS

In order to more clearly illustrate the technical solution in the embodiments of the present application, the drawings used in the description of the embodiments will be briefly described below. Obviously, the drawings in the following description are some embodiments of the present application. Those skilled in the art can also obtain other drawings based on these drawings without paying any creative work.

FIG. 1 is a schematic diagram illustrating the structure of a computing device according to an embodiment of the present application.

FIG. 2 is a flow schematic diagram of a multi-person mode full-language implementation method according to an embodiment of the present application.

FIG. 2a is a schematic diagram illustrating the structure of an AI translator.

FIG. 3 is a schematic diagram of a cyclic neural network according to an embodiment of the present application.

FIG. 4 is a schematic diagram of a terminal according to an embodiment of the present application.

### DESCRIPTION OF THE EMBODIMENTS

The technical solution in the embodiments of the present application is clearly and completely described below with reference to the accompanying drawings in the embodiments of the present application. Obviously, the described embodiments are a part of the embodiments of the present application, rather than all of the embodiments. All other embodiments obtained by those skilled in the art based on the embodiments of the present application without paying any creative work are within the scope of protection of the present application.

The terms, such as “first”, “second”, “third” and “fourth” etc., in the specification and claims of the present application and the accompanying drawings are used to distinguish different objects, and are not intended to describe a specific order. Furthermore, the terms “comprise” and “have” and any variations thereof are intended to cover a non-exclusive inclusion. For example, a process, method, system, product, or device that comprises a series of steps or units is not limited to the listed steps or units, but optionally comprises steps or units that are not listed, or optionally comprises other steps or units inherent to these processes, methods, products or devices.

References to “an embodiment” herein mean that a particular feature, structure, or characteristic described in connection with the embodiments can be included in at least one embodiment of the present application. The appearances of the phrase in various places in the specification are not necessarily referring to the same embodiments, and are not exclusive or alternative embodiments that are mutually exclusive from other embodiments. Those skilled in the art will explicitly and implicitly understand that the embodiments described herein can be combined with other embodiments.

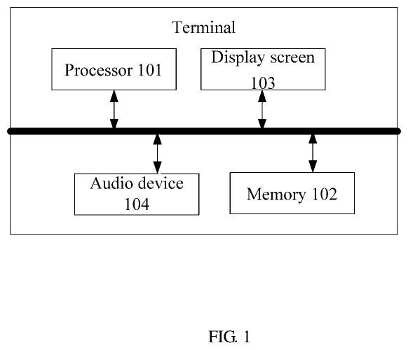

Referring to FIG. 1, FIG. 1 is a schematic diagram illustrating the structure of a terminal. As shown in FIG. 1, the terminal may comprise: a processor 101, a memory 102, a display screen 103, and an audio device 104, wherein the processor 101 is connected to the memory 102, the display screen 103, and the audio device 104 via a bus. The above audio component may be a microphone, and of course may also comprise a headset.

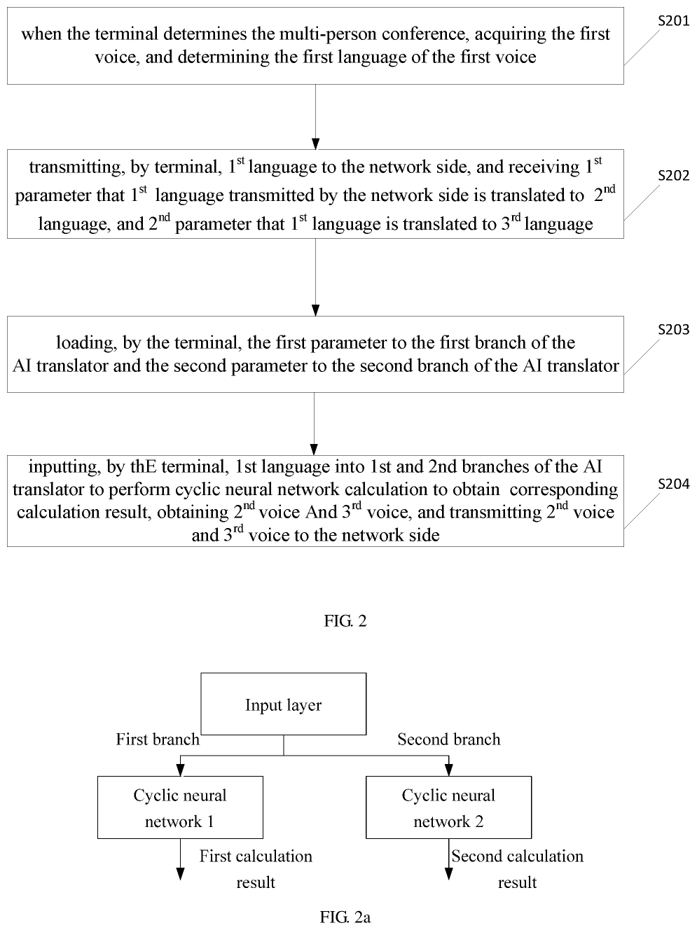

The multi-person mode full-language implementation method according to the present application is implemented using a terminal as shown in FIG. 1. As shown in FIG. 2, the method comprises the steps of:

Step S201: when the terminal determines the multi-person conference, acquiring the first voice, and determining the first language of the first voice;

Step S202: transmitting, by the terminal, the first language to the network side, and receiving the first parameter that the first language transmitted by the network side is translated to the second language, and the second parameter that the first language is translated to the third language;

Step S203: loading, by the terminal, the first parameter to the first branch of the AI translator and the second parameter to the second branch of the AI translator; and

Step S204: inputting, by the terminal, the first language into the first branch and the second branch of the AI translator, respectively, to perform a cyclic neural network calculation to obtain the first calculation result and the second calculation result, obtaining the second voice matching with the second language according to the first calculation result, obtaining the third voice matching with the third language according to the second calculation result, and transmitting the second voice and the third voice to the network side.

Obtaining the second voice matching with the second language according to the first calculation result and obtaining the third voice matching with the third language according to the second calculation result may be implemented using the existing AI translator, such as a method of a Baidu AI translator, a Huawei AI translator, and a Google AI translator. The present application does not limit the specific method.

When determining the first language, the technical solution provided by the present application requests the translation parameter of the first language from the network side, and when receiving two parameters, loads the two parameters in the corresponding branches, and then performs the operations, respectively. In this way, it is possible to realize the translation of two or more languages simultaneously with one original voice, which improves the translation speed without manual intervention, reduces the cost and improves user experience.

The network side may be a device at the core network side in the mobile communication network, and may also be a device at other network side. The specific device at the network side is not limited in the present application.

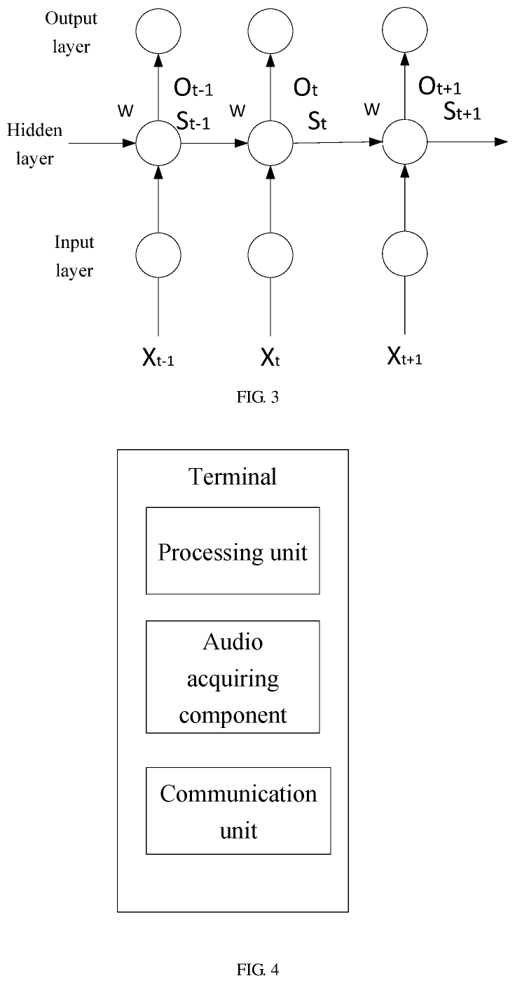

As shown in FIG. 2a, the FIG. 2a is a schematic diagram illustrating the structure of an AI translator. The cyclic neural network of the AI translator is as shown in FIG. 3. As shown in FIG. 2a, both the first branch and the second branch have their own recurrent neural network model, and can share the input layer since the original voice is the same.

The operation of the cyclic neural network is illustrated below, taking the first branch as an example. For the second branch, the cyclic neural network operation is similar to that of the first branch, except that the weight parameters are different. The cyclic neural network is a neural network model commonly used for voice translation. The cyclic neural network has a structure as shown in FIG. 3, comprising an input layer, a hidden layer, and an output layer. The output structure of the hidden layer is used as an input data of the hidden layer of the next time.

As shown in FIG. 3, for example, the output result of the hidden layer at the time t is the output of the hidden layer at the next time t+1.

As shown in FIG. 3, W denotes a weight, Xₜ₋₁ denotes the input data of the input layer at the time t−1, Xₜ denotes the input data of the input layer at the time t, Sₜ₋₁ denotes the output result of the hidden layer at the time t−1, and Oₜ₋₁ denotes the output result of the output layer at the time t−1;

Take time t as an example:

Sₜ=w×Xₜ+w×Sₜ₋₁

Oₜ=ƒ(Sₜ)

Where ƒ denotes an activation function, including, but not limited to, a sigmoid function, a tan h function, etc.

$$sigmoid ( x ) = \frac{1}{1 - {e}^{x}} tanh ( x ) = \frac{{e}^{x} - {e}^{- x}}{{e}^{x} + {e}^{- x}}$$

Of course, in the actual application, other activation functions can also be used.

The terminal inputs the first language into the first branch of the AI translator to perform a cyclic neural network operation to obtain the first calculation result, which specifically comprises:

obtaining the input data Xₜ and the weight W at the time t of the input layer of the cyclic neural network in the first branch, obtaining the output result Sₜ₋₁ at the previous time of the time t of the hidden layer; and calculating the output result Sₜ at the time t of the hidden layer and the first calculation result Oₜ at the time t of the output layer.

The terminal inputs the first language into the second branch of the AI translator to perform the cyclic neural network operation to obtain the second calculation result, which specifically comprises:

obtaining the input data Xₜ and the weight W² at the time t of the input layer of the cyclic neural network in the second branch, obtaining the output result Sₜ₋₁² at the previous time of the time t of the hidden layer; and calculating the output result Sₜ² at the time t of the hidden layer and the second calculation result Oₜ² at the time t of the output layer.

The weights W and W² are parameters obtained from the network side.

Calculating the output result Sₜ at the time t of the hidden layer specifically comprises:

adding the matrix hₜ₋₁*M of the output result Sₜ₋₁ to the matrix hₜ*M of the input data Xₜ to obtain a new matrix (hₜ₋₁+hₜ)*M, where M denotes the row value of the matrix, hₜ₋₁ and hₜ denote the column value of the matrix; calculating the matrix (hₜ₋₁+hₜ)*M and the matrix M*E of the weight W to obtain the calculation result (hₜ₋₁+hₜ)*E, dividing the calculation result ((hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

The technical solution of the present application combines the output result Sₜ₋₁ and the input data Xₜ into a new matrix, so that the quadratic matrix multiplication operation becomes the first-order matrix multiplication operation. Although the calculation amount is the same, the weight W can be transmitted less once if the quadratic matrix operation becomes the first-order matrix multiplication operation, that is, the weight W needs to be only extracted once, which improves the efficiency of data extraction, improves the calculation efficiency, reduces power consumption and reduced heat dissipation.

Optionally, prior to calculating the matrix (hₜ₋₁+hₜ)*M and the matrix M*E of the weight W to obtain the calculation result (hₜ₋₁+hₜ)*E, the above method may further comprise: if the M cannot be divisible by 4, dividing the new matrix (hₜ₋₁+hₜ)*M into m input data blocks in the column direction, wherein the first m−1 input data blocks in the m input data blocks comprise 4 column of elements, and the last input data block comprises r columns of elements; storing the first m−1 input data blocks in rows first and then in columns, and determining the storage mode of the last input data block according to the value of r.

Specifically, the above method may comprise:

if r=1, storing the last column of elements in the column direction, if r=2, storing the last 2 columns of elements in rows first and then in columns, if r=3, adding a column of zero elements at the edge to obtain an added data block, and then storing the added data block in rows first and then in columns. The above r is the remainder of M/4.

where m=[M/4]+1.

The above method may further comprise: if M cannot be divisible by 4, dividing the matrix M*E into m input data blocks in the row direction, wherein the first m−1 input data blocks in the m input data blocks comprise 4 row of elements, and the last input data block comprises r columns of elements; storing the first m−1 input data blocks in columns first and then in rows; if r=1, storing the last row of elements in the row direction, if r=2, storing the last 2 rows of elements in columns first and then in rows, if r=3, adding a row of zero elements at the edge to obtain an added data block, and then storing the added data block in columns first and then in rows.

Referring to FIG. 4, there is provided a terminal, wherein the terminal comprises:

an audio acquiring component configured to, when determining the multi-person conference, acquire the first voice and determine the first language of the first voice;

a processing unit configured to control the communication unit to transmit the first language to the network side, and receive the first parameter that the first language transmitted by the network side is translated to the second language, and the second parameter that the first language is translated to the third language; load the first parameter to the first branch of the AI translator and the second parameter to the second branch of the AI translator; and input the first language into the first branch and the second branch of the AI translator, respectively, to perform a cyclic neural network calculation to obtain the first calculation result and the second calculation result, obtain the second voice matching with the second language according to the first calculation result, obtain the third voice matching with the third language according to the second calculation result, and control the communication unit to transmit the second voice and the third voice to the network side.

The above terminal may specifically be a smart phone or a tablet.

The embodiments of the present application further provide a computer readable storage medium, wherein a computer program for exchanging electronic data is stored in the computer readable storage medium, wherein the computer program causes the computer to perform some or all of the steps of any of the multi-person mode full-language implementation method as described in the above method embodiments.

The embodiments of the present application further provide a computer program product, wherein the computer program product comprises a non-transitory computer readable storage medium in which a computer program is stored, and the computer program is operable to cause the computer to perform some or all of the steps of any of the multi-person mode full-language implementation method as described in the above method embodiments.

It should be noted that, for the sake of brevity, each of the above method embodiments is described as a combination of a series of actions, but those skilled in the art should understand that the present application is not limited by the described action sequence because certain steps may be performed in other sequences or concurrently in accordance with the present application. In addition, those skilled in the art should also understand that the embodiments described in the specification are all optional embodiments, and the actions and modules involved are not necessarily required by the present application.

In the above embodiments, the description of each of the embodiments has its own emphasis, and the parts that are not detailed in a certain embodiment can refer to the related descriptions of other embodiments.

In the several embodiments provided by the present application, it should be understood that the disclosed device may be implemented in other ways. For example, the device embodiments described above are merely illustrative. For example, the division of the unit is only a logical function division. In actual implementation, there may be another division manner. For example, a plurality of units or components may be combined or may be integrated into another system, or some features may be ignored or not executed. In addition, the mutual coupling or direct coupling or communication connection shown or discussed may be an indirect coupling or communication connection through some interfaces, devices or units, and may be electrical or in other forms.

The units described as separate components may or may not be physically separated, and the components displayed as units may or may not be physical units, that is, may be located in one place, or may be distributed to a plurality of network units. Some or all of the units may be selected according to actual needs to achieve the purpose of the solution of the embodiment.

In addition, each of the functional units in each of the embodiments of the present application may be integrated into one processing unit, or each of the units may exist physically separately, or two or more of the units may be integrated into one unit. The above integrated unit may be implemented in the form of hardware or in the form of a software program module.

If implemented in the form of a software program module and sold or used as a standalone product, the integrated unit may be stored in a computer readable memory. Based on such understanding, the technical solution of the present application in essence, or the part making contributions to the prior art, or all or some of the technical solution may be embodied in the form of a software product. The computer software product is stored in a memory, comprising several instructions to cause the computer device (which may be a personal computer, a server or a network device, etc.) to perform all or some of the steps of the methods described in each of the embodiments of the present application. The above memory comprises various media, such as: a USB flash disk, a Read-Only Memory (ROM), a Random Access Memory (RAM), a removable hard disk, a magnetic disk, or an optical disk, in which program codes may be stored.

Those skilled in the art can understand that all or some of steps in each of the methods of the above embodiments can be completed by a program to instruct related hardware. The program can be stored in a computer readable memory, and the memory may comprise: a flash drive, a Read-Only Memory (ROM), a Random Access Memory (RAM), a magnetic disk or an optical disk, etc.

The embodiments of the present application have been described in detail above. Specific examples are applied herein to set forth the principles and embodiments of the present application. The description of the above embodiments is only used to help understand the method of the present application and its core ideas; at the same time, those skilled in the art will have a change in the specific embodiments and the scope of application according to the idea of the present application. In summary, the content of the present specification should not be construed as limiting the present application.

What is claimed is:

1. A multi-person mode full-language implementation method, wherein the method comprises:
when a terminal determines a multi-person conference, acquiring a first voice and determining a first language of the first voice;
transmitting, by the terminal, the first language to a network side, and receiving a first parameter that the first language transmitted by the network side is translated to a second language, and a second parameter that the first language is translated to a third language;
loading, by the terminal, the first parameter to a first branch of an AI translator and the second parameter to a second branch of the AI translator; and
inputting, by the terminal, the first language into the first branch and the second branch of the AI translator respectively, to perform a cyclic neural network calculation to obtain a first calculation result and a second calculation result, obtaining a second voice matching with the second language according to the first calculation result, obtaining a third voice matching with the third language according to the second calculation result, and transmitting the second voice and the third voice to the network side.

2. The method of claim 1, wherein the step of the terminal inputting the first language into the first branch of the AI translator to perform a cyclic neural network operation to obtain the first calculation result comprises:
obtaining an input data Xₜ and a weight W at the time t of an input layer of the cyclic neural network in the first branch, obtaining an output result Sₜ₋₁ at a previous time of the time t of a hidden layer; and calculating an output result Sₜ at the time t of the hidden layer and a first calculation result Oₜ at the time t of the output layer.

3. The method of claim 1, wherein the step of the terminal inputting the first language into the second branch of the AI translator to perform the cyclic neural network operation to obtain the second calculation result comprises:
obtaining an input data Xₜ and a weight W² at the time t of the input layer of the cyclic neural network in the second branch, obtaining an output result Sₜ₋₁² at a previous time of the time t of a hidden layer; and calculating an output result Sₜ² at the time t of the hidden layer and a second calculation result Oₜ² at the time t of the output layer.

4. The method of claim 2, wherein the step of calculating the output result Sₜ at the time t of the hidden layer comprises:
adding a matrix hₜ₋₁*M of the output result Sₜ₋₁ to a matrix hₜ*M of the input data Xₜ to obtain a new matrix (hₜ₋₁+hₜ)*M, wherein M denotes a row value of the matrix, hₜ₋₁ and hₜ denote a column value of the matrix; calculating the matrix (hₜ₋₁+hₜ)*M and the matrix M*E of the weight W to obtain a calculation result (hₜ₋₁+hₜ)*E, dividing the calculation result ((hₜ₋₁+hₜ)*E into the matrix hₜ₋₁*E and the matrix hₜ*E, summing the matrix hₜ₋₁*E and the matrix hₜ*E to obtain an output result Sₜ; and performing an activation operation on Sₜ to obtain Oₜ.

5. A terminal comprising an audio acquiring component, a processing unit, and a communication unit; wherein
the audio acquiring component is configured to, when determining a multi-person conference, acquire a first voice and determine a first language of the first voice;
the processing unit is configured to control the communication unit to transmit a first language to the network side, and receive a first parameter that the first language transmitted by the network side is translated to a second language, and a second parameter that the first language is translated to a third language; load the first parameter to a first branch of an AI translator and the second parameter to a second branch of the AI translator; and input the first language into the first branch and the second branch of the AI translator respectively, to perform a cyclic neural network calculation to obtain a first calculation result and a second calculation result, obtain a second voice matching with the second language according to the first calculation result, obtain a third voice matching with the third language according to the second calculation result, and control the communication unit to transmit the second voice and the third voice to the network side.

6. The terminal of claim 5, wherein the processing unit is configured to obtain an input data Xₜ and a weight W at the time t of the input layer of the cyclic neural network in the first branch, obtain an output result Sₜ₋₁ at a previous time of the time t of the hidden layer; and calculate an output result Sₜ at the time t of a hidden layer and a first calculation result Oₜ at the time t of the output layer.

7. The terminal of claim 5, wherein the processing unit is configured to obtain an input data Xₜ and a weight W² at the time t of the input layer of the cyclic neural network in the second branch, obtain an output result Sₜ₋₁² at the previous time of the time t of a hidden layer; and calculate an output result Sₜ² at the time t of the hidden layer and a second calculation result Oₜ² at the time t of the output layer.

8. The terminal of claim 6, wherein the processing unit is configured to add a matrix hₜ₋₁*M of the output result Sₜ₋₁ to a matrix hₜ*M of the input data Xₜ to obtain a new matrix (hₜ₋₁+hₜ)*M, wherein M denotes a row value of the matrix, hₜ₋₁ and hₜ denote a column value of the matrix; calculate a matrix (hₜ₋₁+hₜ)*M and a matrix M*E of the weight W to obtain a calculation result (hₜ₋₁+hₜ)*E, divide the calculation result ((hₜ₋₁+hₜ)*E into the matrix hₜ₋₁*E and the matrix hₜ*E, sum the matrix hₜ₋₁*E and the matrix hₜ*E to obtain an output result Sₜ; and perform an activation operation on Sₜ to obtain Oₜ.

9. The terminal of claim 5, wherein the terminal is a smart phone or a tablet.

10. A computer readable storage medium in which a computer program for exchanging electronic data is stored, wherein the computer program causes the computer to perform the method of claim 1.
